(19) United States
(12) Patent Application Publication
(10) Pub. No.: US 2008/0048809 A1
(43) Pub. Date: Feb. 28, 2008

(54) NON-CONTACT SWITCH

(75) Inventors: Tomoki NARITA, Aichi (JP); Kenji KANEMARU, Aichi (JP); Takatomo MIZUNO, Aichi (JP); Ryusuke YONEYAMA, Aichi (JP); Tomoya EGUCHI, Aichi (JP)

Correspondence Address: SCULLY SCOTT MURPHY & PRESSER, PC, 400 GARDEN CITY PLAZA, SUITE 300, GARDEN CITY, NY, 11530, US

(73) Assignee: TOKAI RIKA CO., LTD., Aichi (JP)

(21) Appl. No.: 11/776,044

(22) Filed: Jul. 11, 2007

(30) Foreign Application Priority Data
Jul. 12, 2006 (JP) 2006-192078

(51) Int. Cl. H01H 9/00; B60Q 1/44

(52) U.S. Cl. 335/205

(57) ABSTRACT

When a magnetic substance (104) is brought close to or separated away from an MR sensor (102), so that a direction of a magnetic flux (103) caused to flow through the MR sensor (102) is changed, an output voltage from the MR sensor (102) changes. Also, when a change in output voltage from the MR sensor (102) exceeds a threshold set by a designer, a comparison portion (303) judges that switches (309a, 309b) should be turned ON, and outputs suitable signals to corresponding portions, respectively.

### BACKGROUND OF THE INVENTION

1. Field of the Invention

The invention relates to a non-contact switch using a magnetic field sensitive sensor.

2. Description of the Related Art

With regard to the related art, there is known a non-contact switch in which a recess portion is formed in a part of an N pole of a magnet, three sides of the recess portion are surrounded by three N poles, respectively, the recess portion is used as a detection region for detecting a magnetic flux, a magnetic member is adapted to be brought close to the detection region, and a magnetic filed sensitive element is disposed in the detection region. This non-contact switch, for example, is described in Publication of the Translation of International Patent Application No. 9-511357.

According to this non-contact switch, when the magnetic member is displaced from a position away from the detection region to a position close to the detection region, a magnetic flux is generated due to magnetic fluxes caused to flow between the N poles and the magnetic member in the detection region which has been a space having no magnetic flux because the three sides thereof have been surrounded by the N poles, respectively. The generation of this magnetic flux is detected by the magnetic field sensitive element, thereby making it possible to turn ON/OFF a switching circuit.

However, in the conventional non-contact switch described above, a malfunction is caused due to magnetic noises because it is detected whether or not the magnetic flux is generated in the detection region. As a result, there is a limit in enhancement of a detection precision.

### SUMMARY OF THE INVENTION

The invention has been made in the light of the circumstances described above, and it is therefore an object of the invention to provide a non-contact switch which is capable of preventing a malfunction from being caused, and thus enhancing a detection precision.

In order to attain the above-mentioned object, according to an embodiment of the invention, there is provided a non-contact switch, including:

a magnet for generating a magnetic flux directed to a predetermined direction in a detection region;

a magnetic member for changing a direction of the magnetic flux in a reciprocal direction between horizontal and vertical direction in the detection region by being brought close to the detection region;

a magnetic field sensitive sensor for detecting the direction change of the magnetic flux in the detection region; and

a switching circuit for being turned ON/OFF in accordance with a detection output from the magnetic field sensitive sensor.

According to the embodiment of the invention, it is possible to provide the non-contact switch which is capable of preventing a malfunction from being caused, and thus enhancing a detection precision.

### BRIEF DESCRIPTION OF THE DRAWINGS

FIG. 1A is a schematic constructional view showing the case where a magnetic substance of a non-contact switch according to an embodiment of the invention is brought close to an MR sensor;

FIG. 1B is a schematic constructional view showing the case where the magnetic substance of the non-contact switch according to the invention is separated away from the MR sensor;

FIG. 2A is a schematic constructional view of a brake system, within a vehicle, to which the non-contact switch according to the embodiment of the invention is applied;

FIG. 2B is a schematic constructional view of the rear of the vehicle having the brake system to which the non-contact switch according to the embodiment of the invention is applied;

FIG. 3 is a circuit diagram of a schematic circuit structure of a circuit portion of the non-contact switch according to the embodiment of the invention; and

FIG. 4 is a flow chart explaining a braking operation of a vehicle having the non-contact switch according to the embodiment of the invention.

### DETAILED DESCRIPTION OF PREFERRED EMBODIMENTS

A non-contact switch according to an embodiment of the invention will be described in detail hereinafter with reference to the accompanying drawings.

### (Construction)

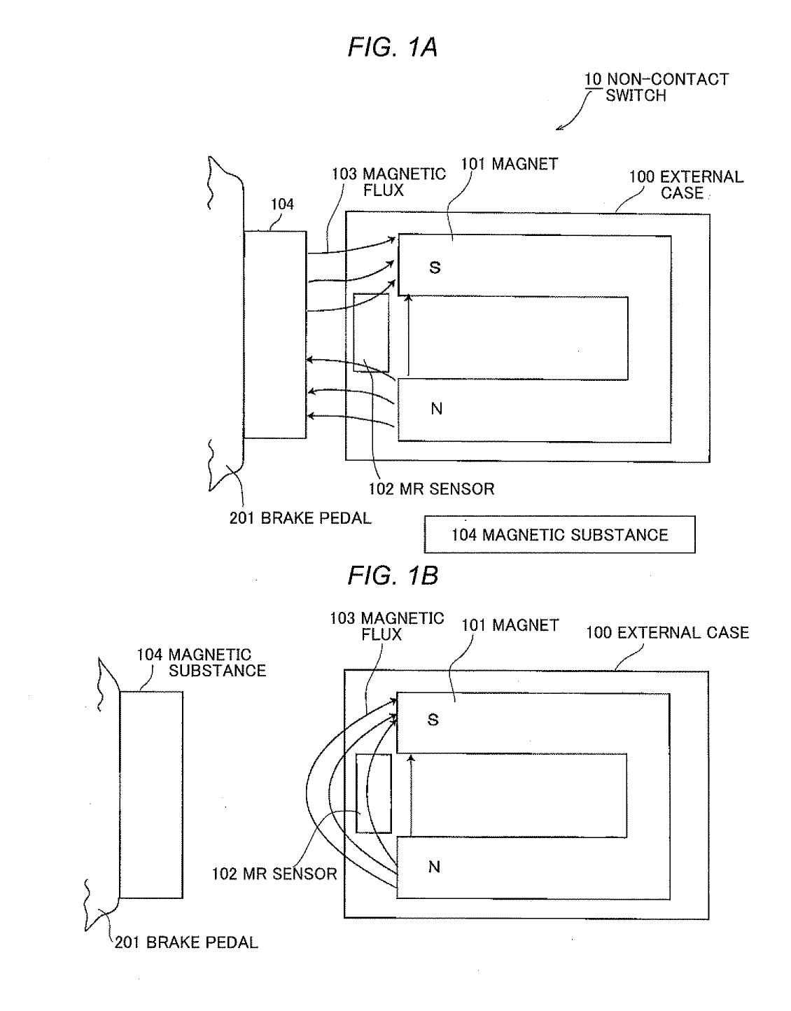

FIG. 1A is a schematic constructional view showing the case where a magnetic substance of a non-contact switch according to an embodiment of the invention is brought close to an MR (magneto-resistive) sensor. FIG. 1B is a schematic constructional view showing the case where the magnetic substance of the non-contact switch according to the invention is separated away from the MR sensor. In each of the cases shown in FIGS. 1A and 1B, respectively, the non-contact switch according to the embodiment of the invention is applied to detection of an actuation of a brake pedal.

FIG. 1A shows a state (a phase of a non-operation) in which no brake pedal 201 is pressed on. In this state, the brake pedal 201 to which a magnetic substance 104 is fixedly fastened faces a non-contact switch 10. A magnet 101 and an MR sensor 102 are accommodated in an external case 100 of the non-contact switch 10. Thus, a magnetic flux 103 which is caused to flow out from an N pole of the magnet 101 is caused to flow into an S pole of the magnet 101 through the magnetic substance 104. In this state, the magnetic flux 103 horizontally crosses the MR sensor 102.

FIG. 1B shows a state (a phase of an operation) in which the brake pedal 201 is pressed on. In this state, the brake pedal 201 is separated away from the non-contact switch 10 in correspondence to the degree that the brake pedal 201 is pressed on. Also, the magnetic flux 103 which is caused to flow out from the N pole of the magnet 101 is caused to flow into the S pole of the magnet 101 without through the magnetic substance 104. Thus, the magnetic flux 103 vertically crosses the MR sensor 102.

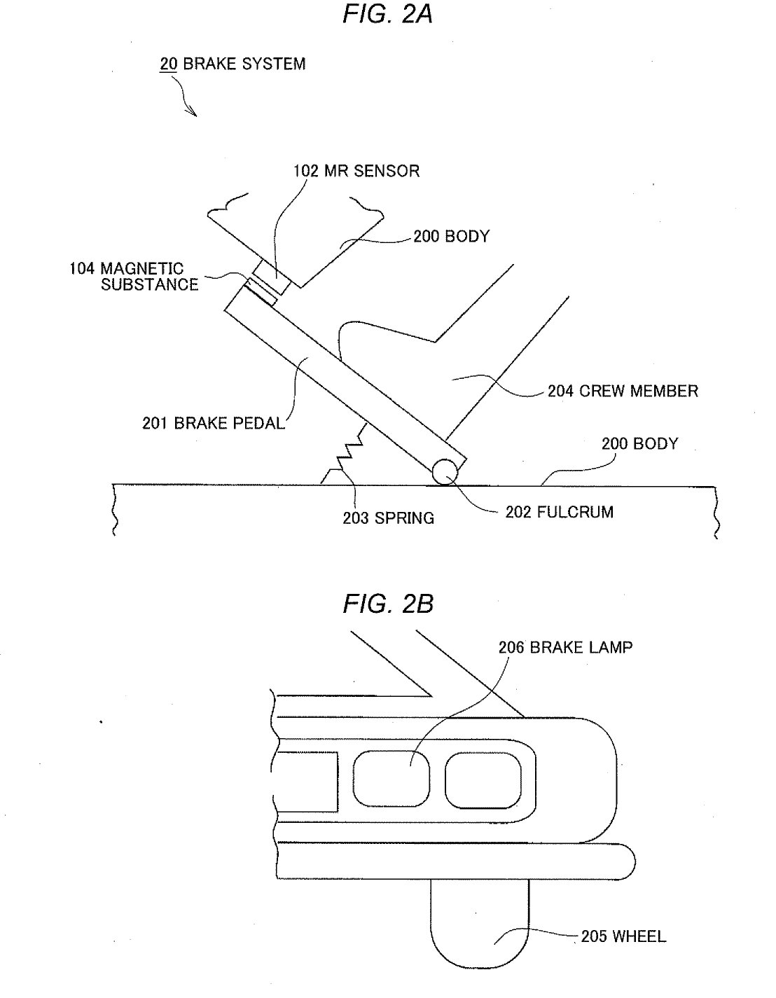

FIG. 2A is a schematic constructional view of a brake system, within a vehicle, to which the non-contact switch according to the embodiment of the invention is applied. FIG. 2B is a schematic constructional view of the rear of the vehicle having the brake system to which the non-contact switch according to the embodiment of the invention is applied.

Referring now to FIG. 2A, the brake system 20 includes the MR sensor 102 disposed in a body 200, the brake pedal 201 which is disposed so as to be slightly separated away from the MR sensor 102, and which has the magnetic substance 104 fixedly fastened to its head, a fulcrum 202 at which the brake pedal 201 is supported to the body 200, and a spring 203 which is disposed between the brake pedal 201 and the body 200, and which returns the brake pedal 201 back to an initial position. With this construction, the brake pedal 201 is adapted to be pressed on by a crew member.

Referring now to FIG. 2B, a brake lamp 206 is provided in the rear of the vehicle, and the vehicle is supported by wheels 205.

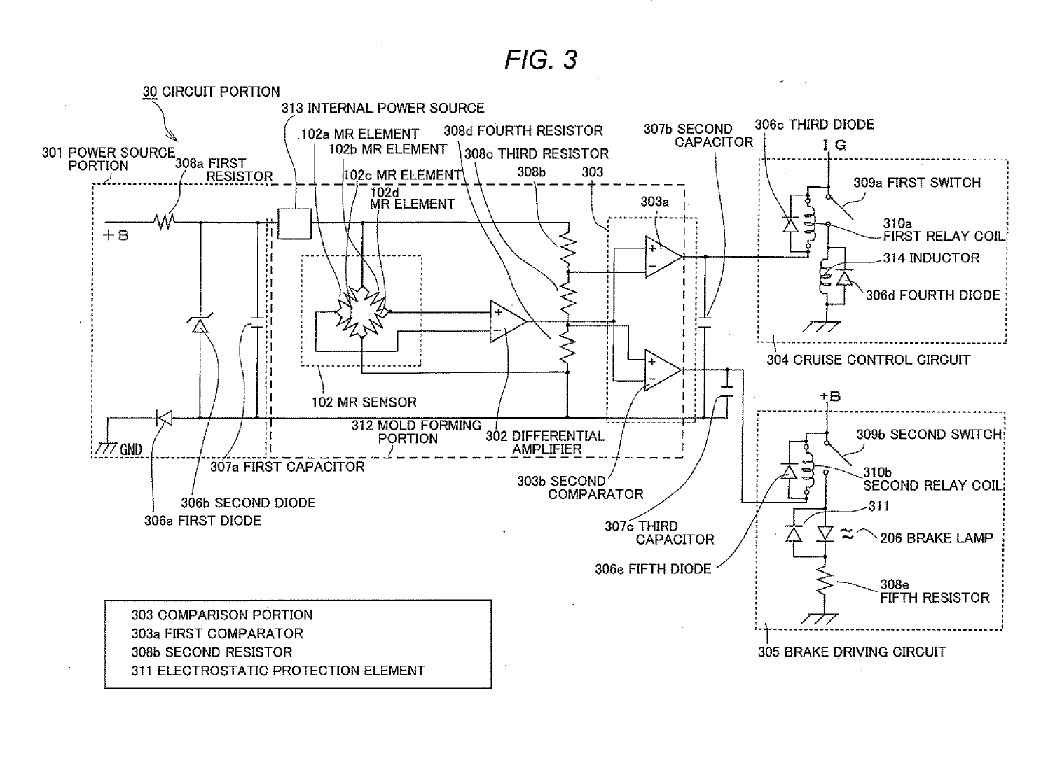

FIG. 3 is a circuit diagram of a schematic circuit structure of a circuit portion of the non-contact switch according to the embodiment of the invention.

A circuit portion 30 includes a power source portion 301 which has a first resistor 308a, a first diode 306a, a second diode 306b (Zener diode), and a first capacitor 307a, and to which a power source +B is supplied from a battery provided in the vehicle, the MR sensor 102 having four MR elements 102a to 102d structured into a bridge circuit, an internal power source 313 connected to the power source portion 301, a differential amplifier 302 which amplifies a change in output voltage from the MR sensor 102, a comparison portion 303 which has a first comparator 303a and a second comparator 303b, and which outputs output signals each representing a change in output voltage from the differential amplifier 302 in the form of turn-ON/OFF signals for first and second switches 309a and 309b, a group of series-connected resistors consisting of a second resistor 308b, a third resistor 308c, and a fourth resistor 308d which are connected in series between the MR sensor 102 and the comparison portion 303, a cruise control circuit 304 which has a third diode 306c, a fourth diode 306d, a first switch 309a, a first relay coil 310a, and an inductor 314, and which performs cruise control for maintaining a set speed without continuing to press on an accelerator during traveling or the like at a high speed, a brake driving circuit 305 which has a fifth diode 306e, a fifth resistor 308e, a second switch 309b, a second relay coil 310b, an electrostatic protection element 311, and the brake lamp including a plurality of light emitting elements, and which turns ON the brake lamp 206, a second capacitor 307b connected between an output of the first comparator 303a and a ground line, and a third capacitor 307c connected between an output of the second comparator 303b and the ground line.

Here, a mold forming portion 312 is obtained by integrating the MR sensor 102, the internal power source 313, the second resistor 308b, the third resistor 308c, the fourth resistor 308d, the differential amplifier 302, and the comparison portion 303 with one another through mold forming, and is accommodated in the external case 100 (not shown) of the non-contact switch 10.

### (Operation)

An operation of the non-contact switch according to the embodiment of the invention will be described in detail hereinafter with reference to FIGS. 1A and 1B to FIG. 4.

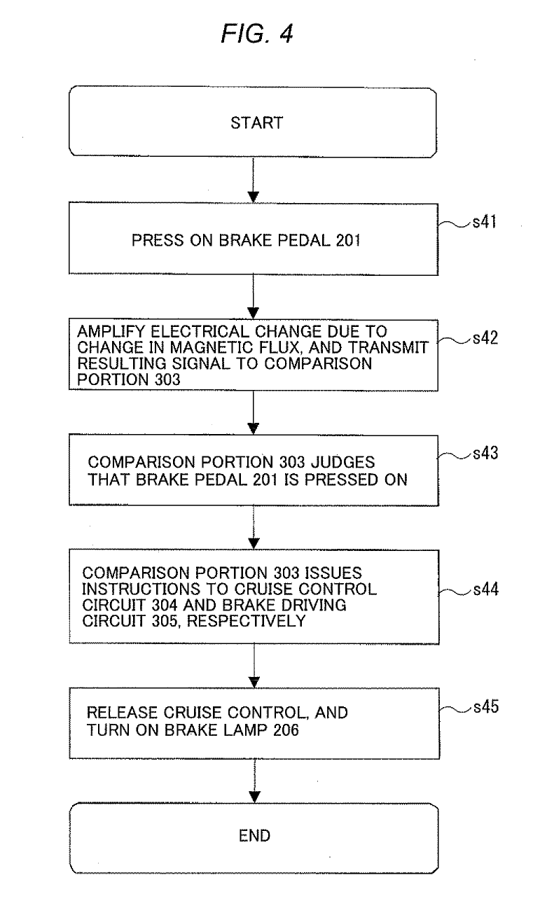

FIG. 4 is a flow chart explaining a braking operation of the vehicle having the non-contact switch according to the embodiment of the invention.

In the operation which will be described below, when the direction of the magnetic flux 103 is changed, the output signal from the MR sensor 102 changes accordingly, and when a level of the output signal from the MR sensor 103 exceeds a threshold, the comparison portion 303 outputs the turn-ON signals for the first and second switches 309a and 309b.

When a user presses on the brake pedal 201 (Step S41), the magnetic substance 104 mounted to the head of the brake pedal 201 is separated away from the MR sensor 102. As a result, the direction of the magnetic flux 103 caused to flow through the MR sensor 102 is changed from the direction shown in FIG. 1A to the direction shown in FIG. 1B, and this change in direction of the magnetic flux 103 is outputted in the form of an output signal representing a change in output voltage from the bridge circuit of the MR sensor 102. The differential amplifier 302 amplifies the output signal from the bridge circuit of the MR sensor 102, and transmits the output signal thus amplified to the comparison portion 303 (Step S42). Thus, the comparison portion 303 judges that the brake pedal 201 is pressed on in accordance with the output signal thus transmitted thereto (Step S43). Also, the first comparator 303a of the comparison portion 303 outputs a release signal to the cruise control circuit 304 to operate the first relay coil 310a, thereby turning ON the first switch 309a. As a result, the cruise control made by the cruise control circuit 304 is released. On the other hand, the second comparator 303b of the comparison portion 303 outputs a turn-ON signal to the brake driving circuit 305 to operate the second relay coil 310b, thereby turning ON the second switch 309b. As a result, the brake lamp 206 is turned ON (Step S44) In the manner as described above, the cruise control is released and the brake lamp 206 is turned ON (Step S45).

According to the embodiment of the invention, it is possible to provide the non-contact switch which is capable of preventing a malfunction from being caused, and thus enhancing a detection precision.

It should be noted that the invention is not intended to be limited to the above-mentioned embodiment. For example, although the release of the cruise control, and the turn-ON of the brake lamp have been described in the above-mentioned embodiment, it is to be understood that the invention can also be applied to other control for an illumination or the like for the inside of an accommodation box of an instrument panel, and can also be applied to any other suitable applications other than the vehicles.

What is claimed is:

1. A non-contact switch, comprising:
a magnet for generating a magnetic flux directed to a predetermined direction in a detection region;
a magnetic member for changing a direction of the magnetic flux in a reciprocal direction between horizontal and vertical direction in said detection region by being brought close to said detection region;
a magnetic field sensitive sensor for detecting the direction change of the magnetic flux in said detection region; and
a switching circuit for being turned ON/OFF in accordance with a detection output from said magnetic field sensitive sensor.

2. A non-contact switch according to claim 1, wherein said magnetic member comprises a magnetic member which is adapted to be displaced in accordance with an actuation of a brake panel for a vehicle;
said magnetic field sensitive sensor comprises a plurality of MR elements, and a detection circuit for detecting a change in electrical resistance of said plurality of MR elements; and
said switch circuit comprises a switch for turning ON/OFF a brake lamp for said vehicle.

3. A non-contact switch according to claim 2, wherein in a state in which said brake pedal for said vehicle is not pressed on, said brake pedal having said magnetic member fixedly fastened thereto faces said non-contact switch.

4. A non-contact switch according to claim 2, wherein in a state in which said brake pedal for said vehicle is pressed on, said brake pedal having said magnetic member fixedly fastened thereto is separated away from said non-contact switch.

5. A non-contact switch according to claim 2, wherein at least said magnet, and said plurality of MR elements are accommodated in an external case.

6. A non-contact switch according to claim 5, wherein said magnet, and said plurality of MR sensors are accommodated integrally with each other in an inside of said external case through mold forming.

7. A non-contact switch according to claim 2, wherein when a direction of the magnetic flux is changed, an output voltage from said plurality of MR elements changes, and when the output voltage from said plurality of MR elements exceeds a threshold, said plurality of MR elements output a turn-ON signal for said switch.

8. A non-contact switch according to claim 2, wherein said detection circuit comprises:
a bridge circuit having said plurality of MR elements;
a differential amplifier for amplifying an output from said bridge circuit; and
a comparison circuit for comparing an output from said differential amplifier with a reference value.

9. A non-contact switch according to claim 8, wherein said detection circuit is driven through an internal power source connected to a power source portion of said vehicle.

10. A non-contact switch according to claim 2, wherein said brake lamp for said vehicle comprises a plurality of light emitting diodes which are protected by a diode for electrostatic protection.

11. A non-contact switch according to claim 8, wherein said comparison circuit comprises:
a first comparison circuit for controlling a cruise control circuit; and
a second comparison circuit for controlling said switch for turning ON/OFF said brake lamp for said vehicle.

12. A non-contact switch according to claim 11, wherein said second comparison circuit outputs a turn-ON signal to a brake driving circuit, thereby turning ON said brake lamp for said vehicle.

13. A non-contact switch according to claim 11, wherein said first comparison circuit outputs a release signal to said cruise control to turn ON said switch, thereby releasing cruise control.
